(19) United States
(12) Patent Application Publication
(10) Pub. No.: US 2002/0080454 A1
(43) Pub. Date: Jun. 27, 2002

(54) Method, system and apparatus for optically transferring information

(76) Inventors: Marcel F.C. Schemmann, Maria-Hoop (NL); Zoran Maricevic, Manlius, NY (US)

Correspondence Address: Wayne F. Reinke, Esq., Heslin & Rothenberg, P.C., 5 Columbia Circle, Albany, NY, 12203-5160, US

(21) Appl. No.: 09/748,750

(22) Filed: Dec. 26, 2000

(51) Int. Cl. H04B 10/04; H04B 10/12

(52) U.S. Cl. 359/181; 359/180; 359/173

(57) ABSTRACT

Information is optically transferred by generating an optical carrier signal having a first polarization state, generating an optical data signal separate from the optical carrier signal and having a second polarization state, matching the first polarization state and the second polarization state, combining the optical carrier signal with the optical data signal to create a combined optical signal, transferring the combined optical signal over an optical wave guide, and receiving the combined optical signal from the optical wave guide.

### BACKGROUND OF THE INVENTION

1. Technical Field

The present invention generally relates to transferring information via an optical wave guide. More particularly, the present invention relates to the generation of an optical carrier signal and a separate optical data signal for transferring information via an optical wave guide.

2. Background Information

Due to increased demand for data transport capacity in recent years, systems have been developed that transport OC-192 (9.95 Gbps) or similar data formats over standard single mode fiber (SMF). This type of fiber is predominant in present optical communication systems. Due to dispersive properties of these fibers, data transport distance for OC-192 standard 9.95 Gbps rate is limited to approximately 65 km. This distance can, however, be enhanced by the use of more expensive fibers such as Corning's Non-zero Dispersion Shifted (NZ-DSF) LEAF fibers or Lucent's TRUE-WAVE NZ-DSF fibers. In order to further increase the capacity carried on a single fiber, Dense-Wavelength-Division-Multiplexing (DWDM) systems have been developed that carry many different colors of radiation on a single fiber with each radiation color carrying a high data rate such as OC-192. This DWDM solution offers increased bandwidth

Since the required data rates are ever increasing, there remains a need for further increasing the data rates carried per wavelength beyond OC-192, such as, for example, to OC-384 (20 Gbps), OC-768 (40 Gbps) or beyond.

### SUMMARY OF THE INVENTION

Briefly, the present invention satisfies the need for increased data rates by providing separate optical carrier and optical data signals, matching the polarization states thereof, combing the signals and transferring the combined signal over an optical wave guide.

In accordance with the above, it is an object of the present invention to provide for optical transmission of data.

The present invention provides, in a first aspect, a transmitter for optically transferring information. The transmitter comprises an optical carrier signal generator for generating an optical carrier signal having a first polarization state, an optical data signal generator for generating an optical data signal separate from the optical carrier signal and having a second polarization state, and means for matching the first and second polarization states.

The present invention provides, in a second aspect, a system for optically transferring information. The system comprises the transmitter of the first aspect, together with a combiner for combining the optical carrier signal with the optical data signal to produce a combined signal. The system further comprises an optical wave guide for transferring the combined signal, and a receiver coupled to the optical wave guide for receiving the combined signal.

The present invention provides, in a third aspect, a method for optically transferring information. The method comprises generating an optical carrier signal having a first polarization state generating an optical data signal separate from the optical carrier signal and having a second polarization state, matching the first polarization state and the second polarization state, combining the optical carrier signal with the optical data signal to create a combined optical signal, and transferring the combined optical signal over an optical wave guide.

These, and other objects, features and advantages of this invention will become apparent from the following detailed description of the various aspects of the invention taken in conjunction with the accompanying drawings.

### BRIEF DESCRIPTION OF THE DRAWINGS

FIG. 1 is a high-level block diagram of one example of an optical communication system in accordance with the present invention.

FIG. 2 is a more detailed block diagram of the system of FIG. 1.

FIG. 3 is a block diagram of another optical communication system in accordance with the present invention.

FIG. 4 is a block diagram of another example of an optical communication system in accordance with the present invention.

FIG. 5 is a block diagram of a variation in design of the system of FIG. 4.

FIG. 6 is a block diagram of a variation in design of the system of FIG. 3.

FIG. 7 depicts a signal spectra for explaining the general operation of the systems of FIGS. 3-6.

### DETAILED DESCRIPTION OF THE DRAWINGS

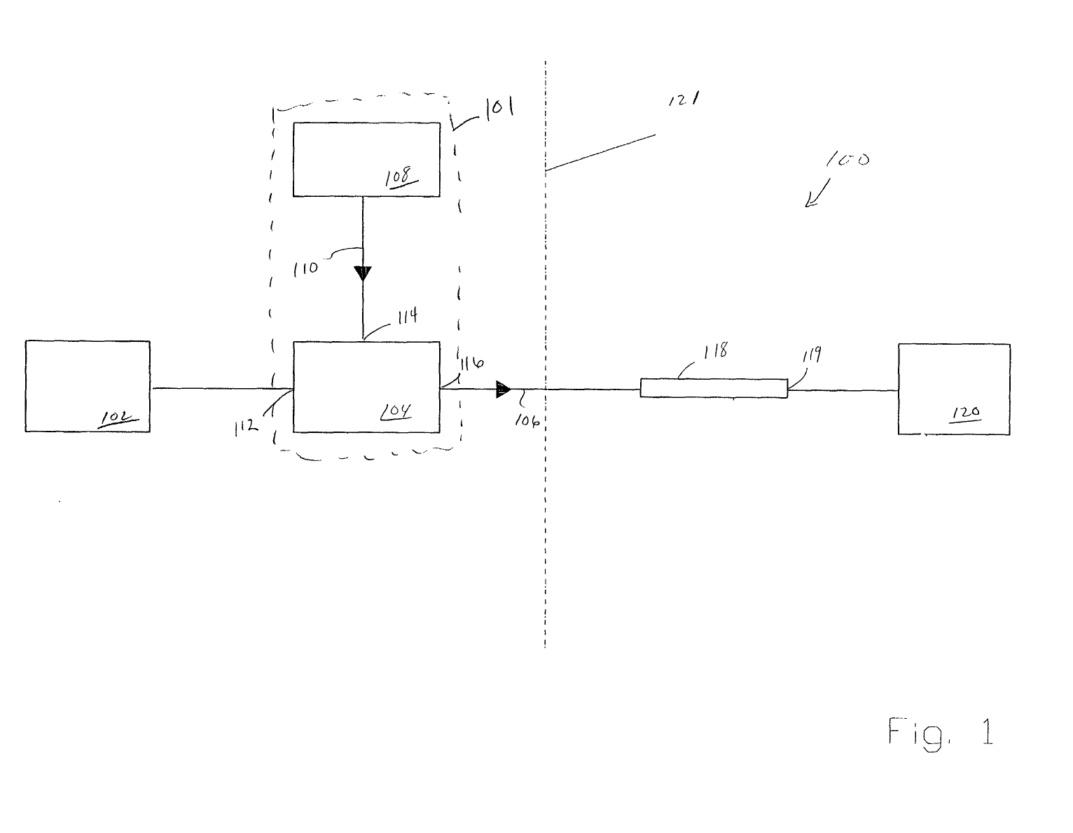

FIG. 1 shows an optical communication system 100. A transmitter 101 in accordance with the invention comprises a radiation source 102 for generating coherent light, modulator 104, for generating an optical carrier signal 106, and an electrical signal generator 108 for generating an electrical carrier signal 110. The radiation source is preferably implemented by a laser diode to generate coherent radiation. The transmitter could, for instance, be implemented on a single crystal. The modulator has an optical input 112 which receives the light from the radiation source. The light may be visible light or invisible light; that is to say, light having frequencies which can not be seen by human beings. The modulator also has an electrical input 114 which receives the electrical carrier signal. The modulator further has an optical output 116 for delivering the optical carrier signal. The optical carrier signal is modulated by the electrical carrier signal and can be put onto a waveguide, such as, for example, an optical fiber 118. While various kinds of optical wave guides can be used, even free space, an optical fiber is typically used for long distance applications. At an output 119 of the fiber, a receiver 120 can be coupled for recovery of the electrical carrier signal from the optical carrier signal. In FIG. 1, the optical fiber and the receiver are shown at the right (receiver) side of vertical striped line 121, while the elements to the left of the line are on the transmission side. The electrical carrier signal has a fixed basic frequency. Therefore, the optical carrier signal does not comprise any data in this example. The optical carrier signal may be used in conjunction with one or more optical signals which are modulated with data to be transferred via the optical fiber to the receiver. Thus, the optical carrier signal may be used by the receiver for locking at the frequency of the electrical carrier signal, which is derived from the optical carrier signal.

In order to increase the data rates of optical signals as much as possible, the optical carrier signal is typically modulated with an electrical carrier signal having a frequency as high as possible. For this reason, the modulator and the electrical signal generator may be (but is not necessarily) constructed such that the optical carrier signal is modulated by the second harmonic of the electrical carrier signal. If so constructed, the optical carrier signal is thus modulated with a modulation frequency which is twice the frequency of the fixed basic frequency. The generation of the second harmonic from the electrical carrier signal can be obtained by any known manner. It will be understood, however, that the first order harmonic, or a harmonic higher than the second could instead be used.

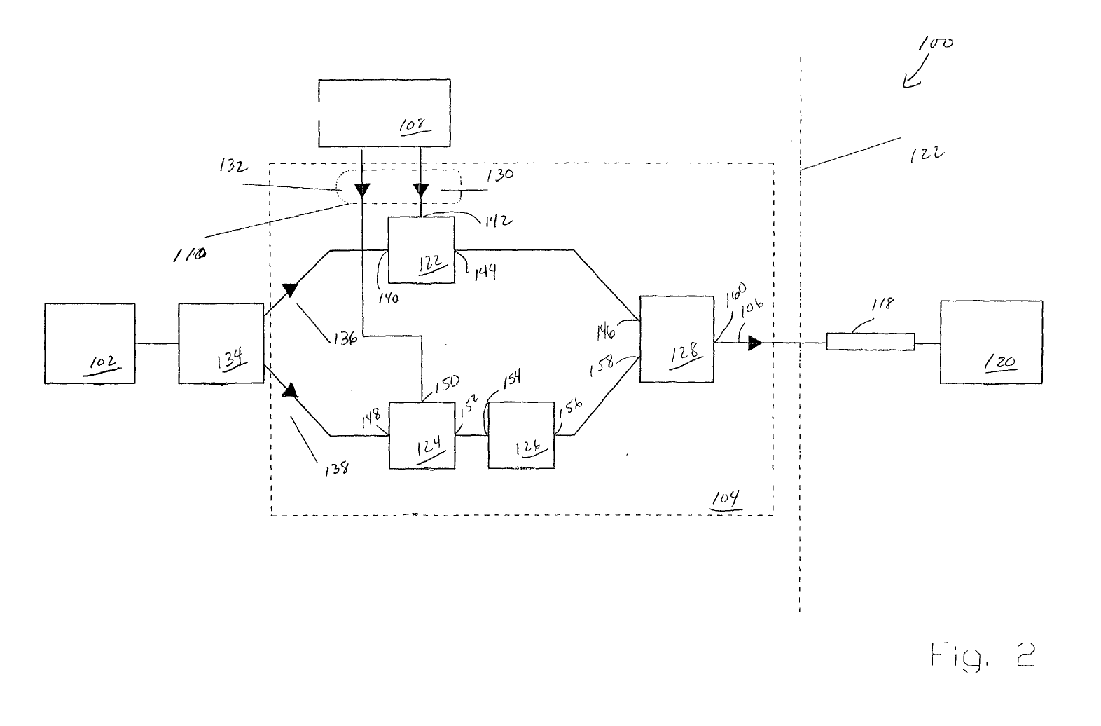

One example of the generation of the second harmonic from the electrical carrier signal 110 is provided in FIG. 2. The modulator is by way of example, implemented by phase modulator 104 and comprises a first optical modulator 122, a second optical modulator 124, a first optical phase shifter 126, and a first optical combiner 128. The electrical carrier signal 110 comprises a first electrical carrier signal 130 and a second electrical carrier signal 132. The light from the laser 102 is split by a first optical splitter 134 into two parts 136 and 138. The first phase modulator has an optical input 140 which receives one of the two parts of the light (here, part 136), an electrical input 142 which receives electrical carrier signal 130, and an output 144 which is coupled to a first input 146 of combiner 128. The second phase modulator has an optical input 148 which receives the other one of the two parts of the light (here, part 138), an electrical input 150 which receives the second electrical carrier signal, and an output 152 which is coupled to an input 154 of phase shifter 126. An output 156 of phase shifter 126 is coupled to a second input 158 of combiner 128. An output 160 of combiner 128 delivers the optical carrier signal 106.

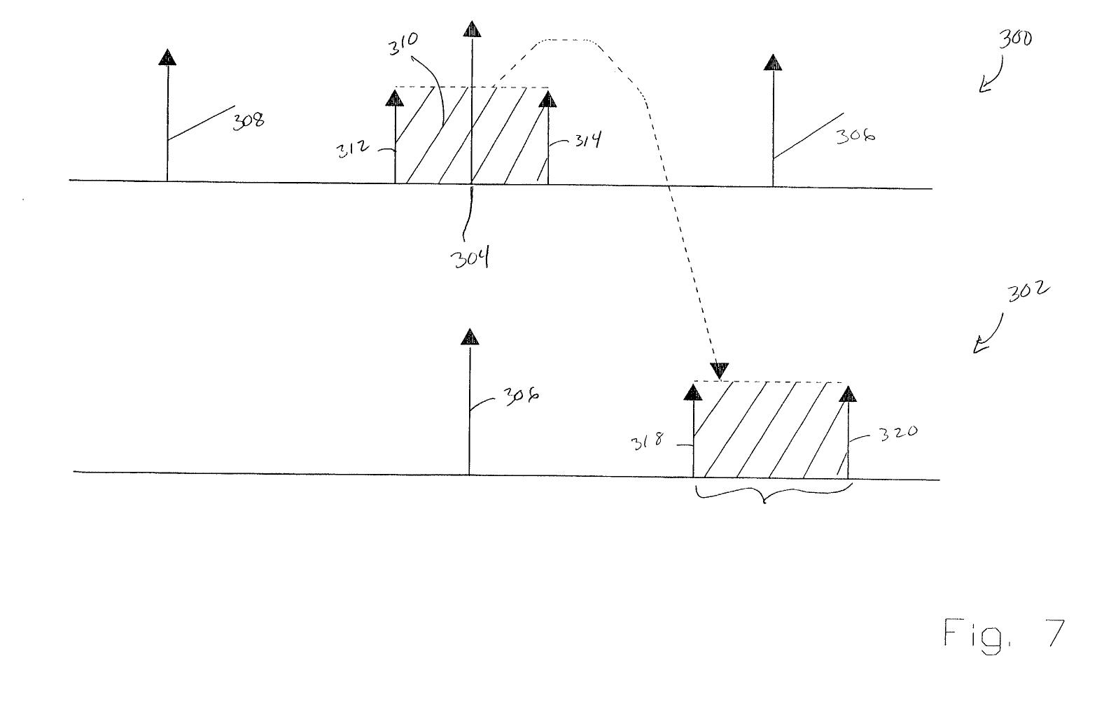

Optical phase shifter 126, the function of which can be accomplished, for example, by a section of wave guide, produces either no shift (i.e., 0 degrees) or a 180 degree shift of the signal out of optical modulator 124, depending on the frequency of electrical carrier signal 132 and how far from the data the side carrier frequency is, i.e., one or two times the frequency of signal 132 (see description of FIG. 7 for side carrier discussion). For example, if the electrical carrier signal frequency is 15 GHz, and the side carrier frequency needs to be 2×15 GHz=30 GHz away from the data, then the optical phase shifter needs to produce a zero degree shift; that way, the needed −30 GHz, 0 GHz and +30 GHz signals are created, while the “odd order” −15 GHz and +15 GHz are canceled. As another example, if the electrical carrier signal frequency is 30 GHz, and the side carrier still needs to be 1×30 GHz=30 GHz away from the data, the need for a 180 degree shift results. With a 180 degree shift, the needed −30 GHz and +30 GHz signals are created while “even order” −60 GHz, 0 GHz and +60 GHz signals are canceled.

The amplitudes of electrical carrier signal 130 and electrical carrier signal 132 are approximately the same, while the phases thereof are approximately opposite. With this measure, and the proper value for the phase shift by phase shifter 126 (here, zero degrees relative to the signal out of optical modulator 122), no odd harmonics are present at the output 160 of combiner 128. This is because the odd harmonics, which include the basic frequency (1^{th} order), are canceled, or at least sufficiently suppressed. The even harmonics are not canceled. Because of the fact that the second order harmonic strongly dominates over the higher order even harmonics, the frequency (relatively to the frequency generated by the laser) by which the optical carrier signal is modulated is twice as high as the frequency of either of carrier signals 130 and 132. As one skilled in the art will know, a phase shift of 180 degrees cancels even harmonics. Thus, for example, if the electrical carrier frequency is 30 GHz, then −30 GHz and +30 GHz signals are generated, with −60 GHz, 0 GHz and +60 GHz being suppressed.

At the outputs of the phase modulators, odd and even harmonics may be generated. The mutual amplitudes and phases of the harmonics can also be chosen in a way that at the output of combiner 128, the odd harmonics, which include the basic first order frequency, are canceled. The even harmonics are not canceled. However, the second order harmonic dominates. Therefore, the frequency (relative to the frequency generated by the laser diode) of the optical carrier signal is about twice the frequency of the carrier signals. This has the advantageous effect that the optical carrier signal is modulated with a frequency which is twice the basic frequency. Thus, if the basic frequency is chosen to be the maximum obtainable frequency in the current state of the art, the maximum modulation frequency of the optical carrier signal is still doubled.

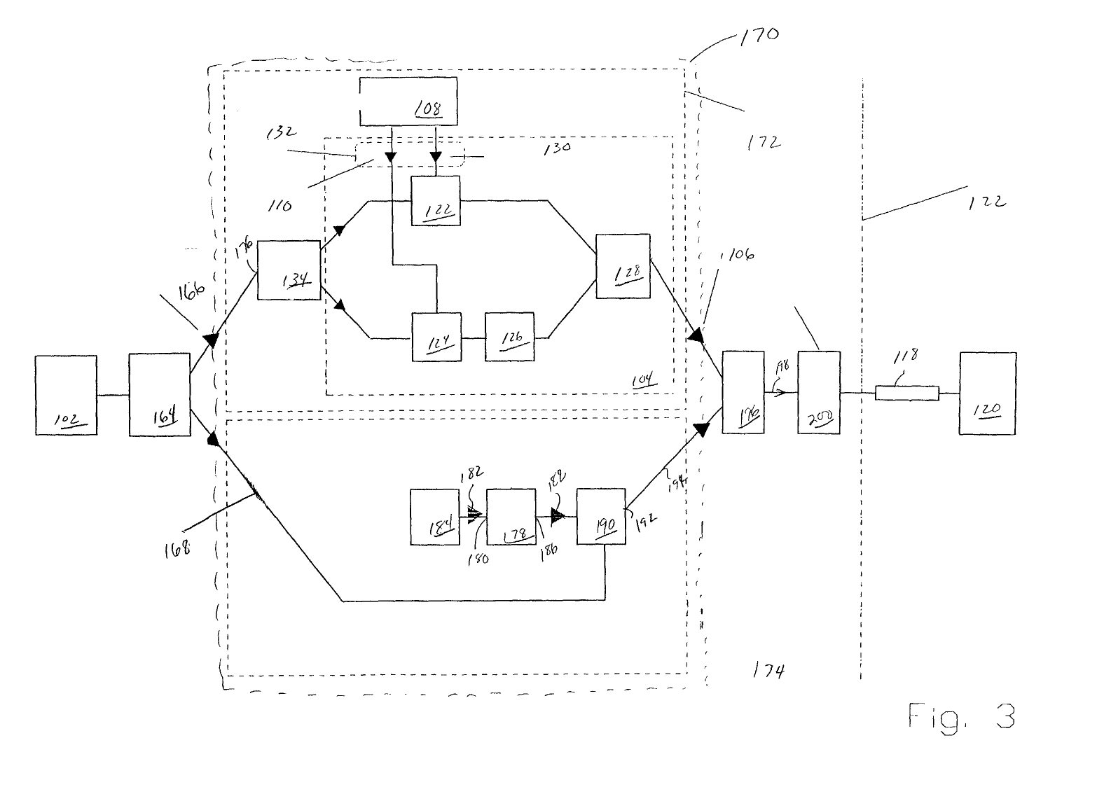

FIG. 3 depicts one example of an optical transmitter 170 in accordance with the present invention, building on that shown in FIG. 2. Light from laser 102 is first split by a second optical splitter 164 into two parts, 166 and 168. The transmitter 170 comprises a first branch 172 and a second branch 174. The first branch comprises phase modulator 104, the electrical signal generator 108, and splitter 134 from FIG. 2. The input 176 of splitter 134 receives part 166 of the light from the laser. The second branch 174 comprises modulator driver 178 having an input 180 for receiving an electrical data signal 182 generated by a data signal generator 184, and an output 186 for sending a drive signal 188 to an amplitude modulator 190. Amplitude modulator 190 also receives part 168 of the light. Modulator 190 further comprises an output 192 coupled to deliver an optical data signal 194 to another combiner 196, which also receives optical carrier signal 106. Amplitude modulator 190 is, by way of example, implemented by a so-called Mach-Zehnder interferometric modulator. The splitting of the radiation into the first and second part enables the possibility of using the first and second branch for separate radiation modulation functions. The first branch can be used to create the optical carrier signal while the second branch can be used to create the optical data signal. This has the advantageous effect that the first branch can be optimized in order to create a very high possible modulation frequency of the optical carrier signal without a penalty with respect to performances of the data signal.

The first and second polarization states, respectively, of the optical carrier signal and the optical data signal are matched by a matching means in a manner that the first and second polarization states are substantially equal. This matching can, for instance, be accomplished with polarization maintaining fibers for one or more of the connections between the optical elements of the transmitter. However, it is not strictly necessary to use polarization maintaining fibers. Polarization states in between the several optical elements may be different as long as the polarization of the optical carrier signal and the optical data signal are approximately the same. In addition, another way to accomplish polarization state matching is to manufacture all needed splitters, phase modulators, phase shifters, combiners, etc., from a single crystal of, for example, Lithium Niobate. This would eliminate the need for separate polarization state matching. Conventional techniques can be used to put the needed elements on a single crystal.

Amplitude modulator 190 is, for example, an external optical modulator for modulating part 168 of the light by data derived from electrical data signal 182, via modulator driver 178. Modulator driver 178 may be, for example, an oscillator which is modulated by electrical data signal 182. Modulator driver 178 may instead be an amplifier. Although various kinds of external optical modulators can be implemented for amplitude modulator 190, a Mach-Zehnder interferometric modulator is preferred, because such Mach-Zehnder modulators are widely used in industry. The combined light signal 198 coming from combiner 196 comprises the optical carrier signal 106 and the optical data signal 194 and is thus equivalently modulated by a complete (carrier+data) RF-signal. This combined light is transferred via optical fiber 118 to the receiver 120. Preferably, before transmitting this combined light over optical fiber 118, the combined light is first filtered through an optical filter 200 in order to remove unwanted (spurious) signals. Alternatively, the optical carrier signal can be filtered prior to combiner 196.

The radiation coming from combiner 196 forms an optical signal modulated by a total RF-signal; that is to say, an RF-signal having one or more unmodulated RF-carriers and having RF-signals with information representing the data of the (first) electrical data signal. The radiation coming from the output of the second combiner is ready for transmission over the wave guide (here, fiber 118). The radiation coming from the output of the wave guide can be coupled to an optical receiver (here, receiver 120). This receiver can then use the optical carrier signal for mixing (detecting) the data and carrier signals and locking at the carrier frequency offset relative to the data.

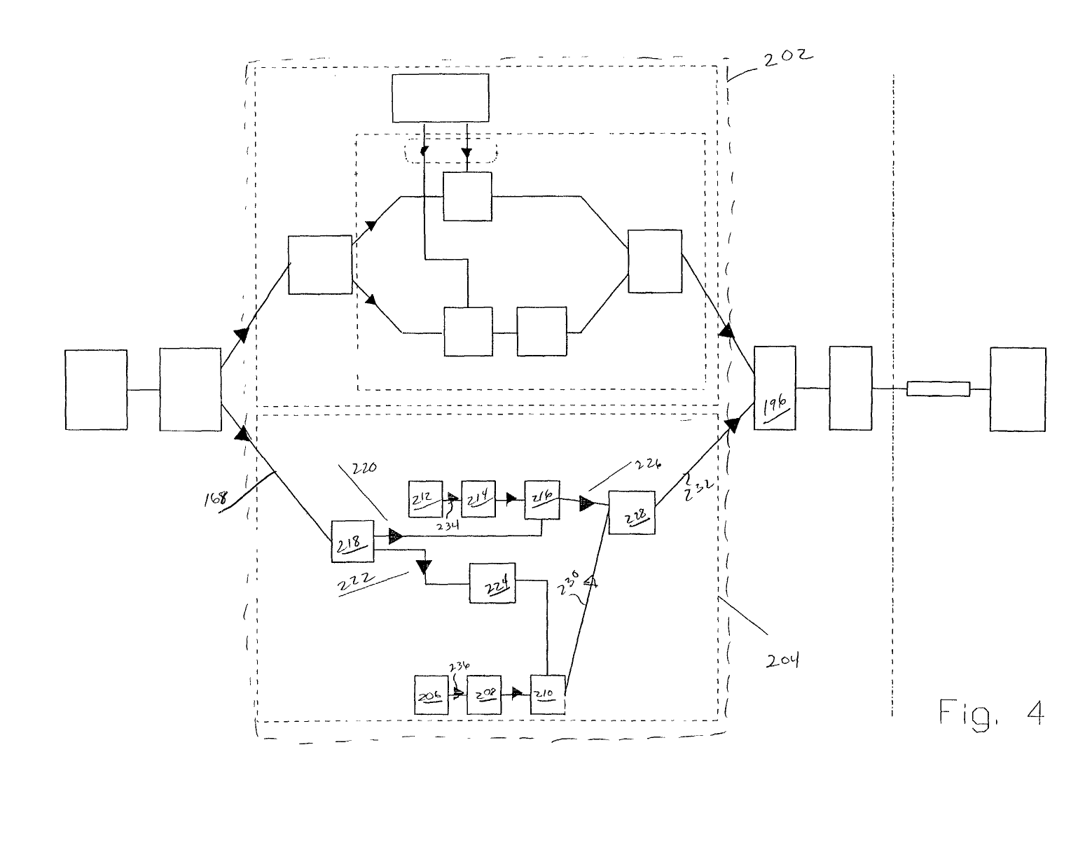

FIG. 4 depicts another embodiment of an optical transmitter 202 in accordance with the invention, replacing branch 174 of FIG. 3. In this embodiment, branch 204 comprises a second group of data signal generator, modulator driver and optical modulator as compared to FIG. 3. Data signal generator 206, modulator driver 208 and optical amplitude modulator 210 are coupled in the same way as the corresponding trio in FIG. 3 (here, data signal generator 212, modulator driver 214 and optical modulator 216), and also have like functions. Part 168 of the light is further split by another splitter 218 into parts 220 and 222. Thus, modulator 216 is now coupled to receive part 220 of the light, while modulator 210 is coupled to receive part 222 of the light via another optical phase shifter 224, the function of which, like optical phase shifter 126, may be accomplished by a section of wave guide. Modulator 216 delivers an optical data signal 226 to a combiner 228. Modulator 210 also delivers an optical data signal 230 to combiner 228. A combined optical data signal 232 is delivered from combiner 228 to combiner 196. The phase shift performed by phase shifter 224 is about 90 degrees with respect to part 220 out of splitter 218. Optical data signals 226 and 230 are modulated in quadrature by electrical data signals 234 and 236, respectively. In the electronics field, quadrature signals are generally referred to as I (in-phase) and Q (quadrature) signals. By this quadrature modulation technique, the information representing the data of electrical data signal 234 is not confused with the data of electrical data signal 236, despite the fact that the frequencies corresponding with the electrical data signals lie within the same frequency band. Thus, by the application of the quadrature modulation technique, the total amount of information which can be transferred is further doubled.

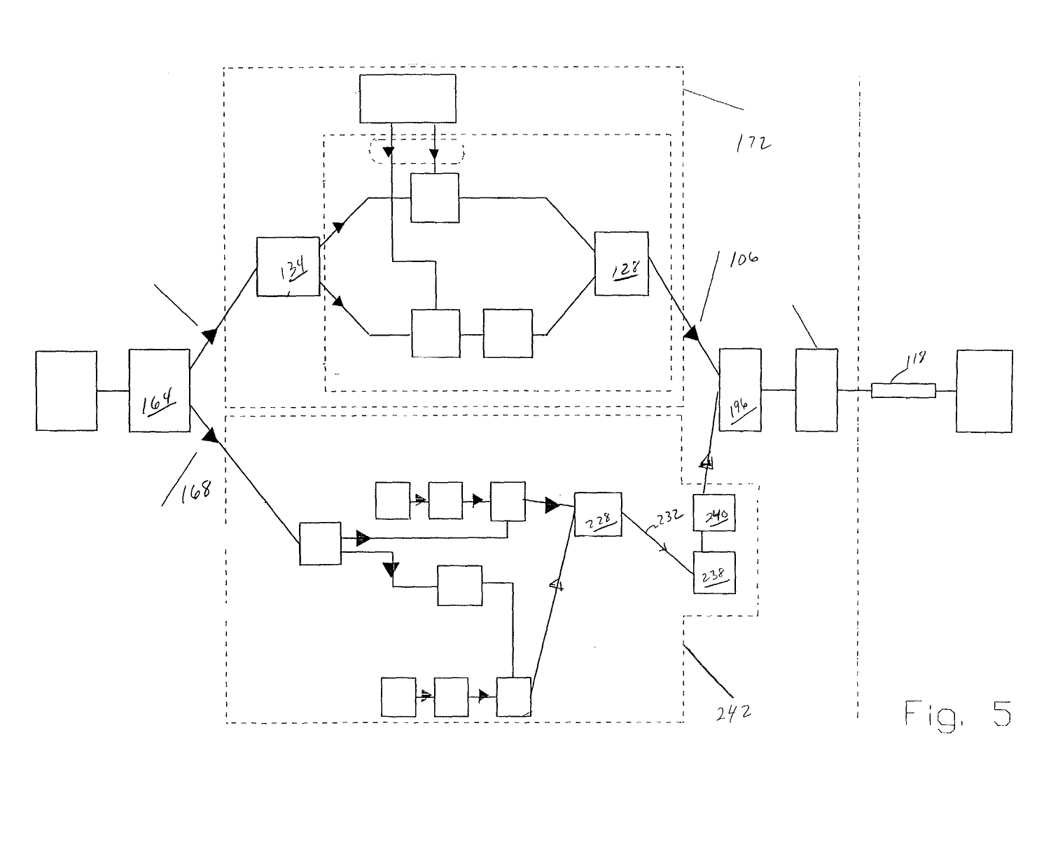

FIG. 5 depicts a variation of branch 204 in FIG. 4. In this variation, another optical phase shifter 238, similar to optical phase shifter 224, and an attenuator 240 are arranged between combiner 228 and combiner 196. The additional shifter and attenuator equalize (or partially equalize) the optical amplitudes between branches 172 and 242, offsetting their respective phases by 180 degrees with respect to each other, for total (or partial) cancellation of part 168 out of data branch 242. Phase shifter 238 and optical attenuator 240 can also be arranged in the other (first) branch. The attenuator is less complex and more economical than amplifying the amplitude. The attenuator must, however, be arranged in the branch having the highest amplitude. So, for instance, phase shifter 238 can also be arranged between splitter 164 and splitter 134, while the attenuator remains at the position shown in FIG. 5.

The FIG. 5 embodiment makes it possible to completely cancel the frequency of the radiation source by controlling the amplitude of optical attenuator 240 and the phase of optical phase shifter 238. This has the advantageous effect that the total radiation energy injected onto the wave guide (here, optical fiber 118) is reduced without any loss of information. It is, however, possible to cancel only a large portion of the frequency of the radiation source. The remaining portion only gives rise to an almost negligible amount of increased radiation energy compared to total cancellation, in which the frequency of the radiation source is completely suppressed.

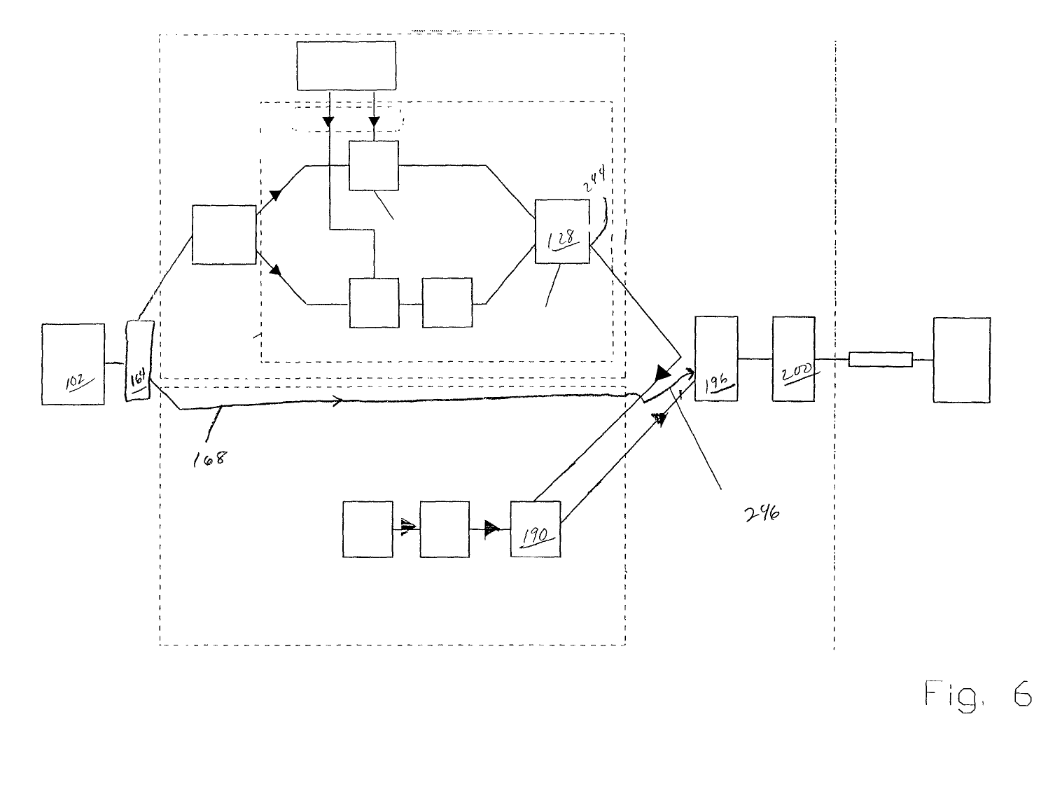

FIG. 6 depicts a variation of the system of FIG. 3. One difference between the systems of FIG. 6 and FIG. 3 is that FIG. 6 provides part 168 of the light having a first polarization state, out of splitter 164 directly to combiner 196. The output 244 of combiner 128, having a second polarization state, is provided to amplitude modulator 190, while part 168 from splitter 164 is provided directly to combiner 196 along with the output of amplitude modulator 190, having a third polarization state. The first polarization state of part 168 and the third polarization state of the output of amplitude modulator 190 are matched and combined by combiner 196. The principle of this variation can also be applied to the embodiments shown in FIGS. 4 and 5. In FIG. 6, the filter 200 can be used to remove unwanted RF modulated carriers from the optical output spectrum and/or to remove unwanted unmodulated carriers, leaving one modulated carrier and one reference signal out of the radiation source. In one embodiment, the frequency of electrical carrier signals 130 and 132 are 30 GHz and optical phase shifter 126 is set for cancellation of even order harmonics. Therefore, the signal from output 244 of combiner 128 is composed of two carriers, each 30 GHz to the left and right side of the frequency of radiation source 102. Amplitude modulator 190 (or a quadrature modulating branch as in FIG. 4) imprints 10 Gbps (20 Gbps if quadrature used) onto both −30 GHz and +30 GHz carriers. This spectrum is combined with part 168 out of splitter 164, at 0 GHz relative to the radiation source frequency. Filter 200 would remove one of the modulated carriers, for example, one at −30 GHz relative to the radiation source frequency.

The embodiments shown in FIGS. 3-6 will now further be explained in conjunction with the signal spectra 300 and 302 of FIG. 7. By way of example, it is assumed that the basic frequency of electrical signals 130 and 110 is equal to 15 GHz with respect to FIGS. 3-5, or equal to 30 GHz with respect to FIG. 6. In order to avoid distortion caused by second order intermodulation, the frequencies generated at the outputs of the modulator drivers (e.g., 214 and 208 in FIG. 4) are preferably not higher than 10 GHz in this example. The frequencies indicated in spectrum 300 of FIG. 7 are relative to the frequency 304 of the (unmodulated) light coming from the laser. Optical carrier signal frequencies 306 and 308 of +30 GHz and −30 GHz, respectively, are generated. One of these +30 GHz and −30 GHz signals may be filtered away by filter 200. In FIG. 7, it is indicated that the data 310 is comprised in the frequency range between frequency 312 of −10 GHz and frequency 314 of +10 GHz. In this example, the frequency range of −10 GHz up to +10 GHz is in fact a Double Side Band (DSB) signal which is, however, in its entirety at one side of the +30 GHz signal (or the −30 GHz signal). Thus, the DSB signal may be interpreted as a Single Side Band signal in relation to the optical carrier signal. The receiver 120 will lock onto the spectrum 302 +30 GHz signal in order to mix this signal with the data. Spectrum 302 shows part of the spectra which will be available in the receiver after locking on the +30 GHz signal. The data signal is available in the frequency range 316 of +20 GHz (318) up to 40 GHz (320), relative to frequency 306, and thus lies substantially within one octave. Any possible second order intermodulation products will fall into unoccupied frequency regions and, thus, cannot lead to a distortion of the transferred information.

So far, the optical carrier signal is by way of example described as a signal which does not comprise any information. It is, however, emphasized that the optical carrier signal may be modulated by an electrical signal comprising information. Thus, the optical carrier signal may carry signal spectrum. In such case, unmodulated light from the laser may, if desired, act as the (reference) carrier for the signal spectrum.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. A transmitter for optically transferring information, comprising:
an optical carrier signal generator for generating an optical carrier signal having a first polarization state;
an optical data signal generator for generating an optical data signal separate from the optical carrier signal and having a second polarization state; and
means for matching the first polarization state and the second polarization state.

2. The transmitter of claim 1, wherein the optical carrier signal generator is capable of generating an optical carrier signal with a dominant second order harmonic.

3. The transmitter of claim 1, wherein the optical carrier signal generator is capable of suppressing odd harmonics.

4. The transmitter of claim 1, wherein the optical carrier signal generator comprises a radio frequency (RF) signal generator for generating at least one RF signal.

5. The transmitter of claim 4, wherein the optical carrier signal generator further comprises at least one phase modulator for modulating radiation with the at least one RF signal to produce at least one modulated signal.

6. The transmitter of claim 5, wherein the at least one RF signal comprises a first RF signal and a second RF signal, wherein the at least one phase modulator comprises a first phase modulator and a second phase modulator, and wherein the optical carrier signal generator further comprises a phase shifter for phase shifting a phase modulated signal from one of the first phase modulator and the second phase modulator to produce a phase shifted signal.

7. The transmitter of claim 6, wherein the optical carrier signal generator further comprises a combiner for combining the phase shifted signal with a phase modulated signal from the other of the first phase modulator and the second phase modulator.

8. The transmitter of claim 1, wherein the optical data signal generator comprises at least one electrical data signal generator.

9. The transmitter of claim 8, wherein the optical data signal generator further comprises at least one amplifier for amplifying the at least one electrical data signal to produce an amplified signal.

10. The transmitter of claim 9, wherein the at least one amplifier comprises a modulator driver.

11. The transmitter of claim 9, wherein the optical data signal generator further comprises at least one modulator for modulating radiation with the amplified signal to produce a modulated data signal.

12. The transmitter of claim 11, wherein the at least one modulator modulates the optical carrier signal with the amplified signal to produce the optical data signal.

13. The transmitter of claim 11, wherein the at least one modulator comprises a Mach-Zehnder interferometric modulator.

14. The transmitter of claim 11, wherein the at least one electrical data signal generator comprises a first electrical data signal generator and a second electrical data signal generator, wherein the at least one amplifier comprises a first amplifier and a second amplifier, wherein the at least one modulator comprises a first modulator and a second modulator, and wherein the optical data signal generator further comprises:
at least one phase shifter for phase shifting the radiation to one of the first modulator and the second modulator; and
a combiner for combining a first modulated signal from the first modulator and a second modulated signal from the second modulator to produce the optical data signal.

15. The transmitter of claim 14, wherein the at least one phase shifter comprises a first phase shifter and a second phase shifter for phase shifting the radiation to the one of the first modulator and the second modulator and phase shifting a combined signal out of the combiner, and wherein the optical data signal generator further comprises an attenuator for attenuating a signal out of the second phase shifter to produce the optical data signal.

16. The transmitter of claim 1, wherein the means for matching comprises polarization maintaining optical fiber.

17. The transmitter of claim 1, wherein the means for matching comprises a single crystal comprising the optical carrier signal generator and the optical data signal generator.

18. A system for optically transferring information, comprising:
a transmitter, comprising:
an optical carrier signal generator for generating an optical carrier signal having a first polarization state;
an optical data signal generator for generating an optical data signal separate from the optical carrier signal and having a second polarization state; and
means for matching the first polarization state and the second polarization state;
a combiner for combining the optical carrier signal with the optical data signal to produce a combined signal;
an optical wave guide for transferring the combined signal; and
a receiver coupled to the optical wave guide for receiving the combined signal.

19. The system of claim 18, wherein the optical wave guide comprises optical fiber.

20. The system of claim 19, wherein the optical fiber comprises single mode optical fiber.

21. The system of claim 18, further comprising a radiation source for providing radiation to the optical carrier signal generator and the optical data signal generator.

22. The system of claim 21, further comprising a splitter for splitting the radiation from the radiation source and providing to the optical carrier signal generator and the optical data signal generator.

23. The system of claim 18, further comprising an optical filter prior to the optical wave guide.

24. The system of claim 18, wherein the optical carrier signal generator is capable of generating an optical carrier signal with a dominant second order harmonic.

25. The system of claim 18, wherein the optical carrier signal generator is capable of suppressing odd harmonics.

26. The system of claim 18, wherein the optical carrier signal generator comprises a radio frequency (RF) signal generator for generating at least one RF signal.

27. The system of claim 26, wherein the optical carrier signal generator further comprises at least one phase modulator for modulating radiation with the at least one RF signal to produce at least one modulated signal.

28. The system of claim 27, wherein the at least one RF signal comprises a first RF signal and a second RF signal, wherein the at least one phase modulator comprises a first phase modulator and a second phase modulator, and wherein the optical carrier signal generator further comprises a phase shifter for phase shifting a phase modulated signal from one of the first phase modulator and the second phase modulator to produce a phase shifted signal.

29. The system of claim 28, wherein the optical carrier signal generator further comprises a combiner for combining the phase shifted signal with a phase modulated signal from the other of the first phase modulator and the second phase modulator.

30. The system of claim 18, wherein the optical data signal generator comprises at least one electrical data signal generator.

31. The system of claim 30, wherein the optical data signal generator further comprises at least one amplifier for amplifying the at least one electrical data signal to produce an amplified signal.

32. The system of claim 31, wherein the at least one amplifier comprises a modulator driver.

33. The system of claim 31, wherein the optical data signal generator further comprises at least one modulator for modulating radiation with the amplified signal to produce a modulated data signal.

34. The system of claim 33, wherein the at least one modulator modulates the optical carrier signal with the amplified signal to produce the optical data signal.

35. The system of claim 33, wherein the at least one modulator comprises a Mach-Zehnder interferometric modulator.

36. The system of claim 33, wherein the at least one electrical data signal generator comprises a first electrical data signal generator and a second electrical data signal generator, wherein the at least one amplifier comprises a first amplifier and a second amplifier, wherein the at least one modulator comprises a first modulator and a second modulator, and wherein the optical data signal generator further comprises:
at least one phase shifter for phase shifting the radiation to one of the first modulator and the second modulator; and
a combiner for combining a first modulated signal from the first modulator and a second modulated signal from the second modulator to produce the optical data signal.

37. The system of claim 36, wherein the at least one phase shifter comprises a first phase shifter and a second phase shifter for phase shifting the radiation to the one of the first modulator and the second modulator and phase shifting a combined signal out of the combiner, and wherein the optical data signal generator further comprises an attenuator for attenuating a signal out of the second phase shifter to produce the optical data signal.

38. The system of claim 18, wherein the means for matching comprises polarization maintaining optical fiber.

39. The system of claim 18, wherein the means for matching comprises a single crystal comprising the optical carrier generator and the optical data signal generator.

40. A method of optically transferring information, comprising:
generating an optical carrier signal having a first polarization state;
generating an optical data signal separate from the optical carrier signal and having a second polarization state;
matching the first polarization state and the second polarization state;
combining the optical carrier signal with the optical data signal to create a combined optical signal; and
transferring the combined optical signal over an optical wave guide.

41. The method of claim 40, wherein generating the optical carrier signal comprises generating the optical carrier signal such that a second order harmonic dominates.

42. The method of claim 40, wherein generating the optical carrier signal comprises generating the optical carrier signal such that odd harmonics are suppressed.

43. The method of claim 42, wherein generating the optical carrier signal comprises:
providing radiation;
generating a first RF signal and a second RF signal;
phase modulating the radiation with each of the first RF signal and the second RF signal to produce a first modulated signal and a second modulated signal, respectively;
phase shifting one of the first modulated signal and the second modulated signal to produce a phase shifted signal; and
combining the phase shifted signal with the other of the first modulated signal and the second modulated signal.

44. The method of claim 43, wherein the phase modulating comprises splitting the radiation into a first part and a second part, wherein phase modulating with the first RF signal comprises phase modulating with one of the first part and the second part, and wherein phase modulating with the second RF signal comprises modulating with the other of the first part and the second part.

45. The method of claim 40, further comprising providing radiation, wherein generating the optical data signal comprises modulating the radiation with an electrical data signal.

46. The method of claim 45, wherein modulating the radiation with the electrical data signal comprises:
amplifying the electrical data signal to produce an amplified signal; and
modulating the radiation with the amplified signal to produce the optical data signal.

47. The method of claim 46, wherein the amplifying comprises amplifying the electrical data signal with a modulator driver.

48. The method of claim 45, wherein the electrical data signal comprises a first electrical data signal and a second electrical data signal, and wherein modulating the radiation with the electrical data signal comprises:
amplifying the first electrical data signal to produce a first amplified signal;
modulating the radiation with the first amplified signal to produce a first optical signal;
phase shifting the radiation to produce phase shifted radiation;
amplifying the second electrical data signal to produce a second amplified signal;
modulating the phase shifted radiation with the second amplified signal to produce a second optical signal; and
combining the first optical signal with the second optical signal to produce the optical data signal.

49. The method of claim 48, wherein the phase shifting comprises phase shifting about 90 degrees.

50. The method of claim 45, wherein the electrical data signal comprises a first electrical data signal and a second electrical data signal, and wherein modulating the radiation with an electrical data signal comprises:
amplifying the first electrical data signal to produce a first amplified signal;
modulating the radiation with the first amplified signal to produce a first optical signal;
phase shifting the radiation to produce a phase shifted radiation;
amplifying the second electrical data signal to produce a second amplified signal;
modulating the phase shifted radiation with the second amplified signal to produce a second optical signal;
combining the first optical signal with the second optical signal to produce a combined optical signal; and
reducing an amplitude of the frequency of the radiation source in the combined optical signal to produce the optical data signal.

51. The method of claim 50, wherein the reducing comprises:
phase shifting the combined optical signal; and
attenuating the phase shifted combined optical signal to produce the optical data signal.

52. The method of claim 40, wherein the matching comprises matching with at least one polarization maintaining optical fiber.

53. The method of claim 40, wherein the transferring comprises transferring the combined optical signal over an optical fiber.

54. A method of optically transferring information, comprising:
generating an optical source signal having a first polarization state;
generating an optical carrier signal from the optical source signal having a second polarization state;
generating an optical data signal from the optical carrier signal having a third polarization state;
matching the first polarization state and the third polarization state;
combining the optical source signal with the optical data signal to create a combined optical signal; and
transferring the combined optical signal over an optical wave guide.

55. The method of claim 54, wherein generating the optical data signal comprises:
generating an electrical data signal;
amplifying the electrical data signal to produce an amplified signal; and
modulating the optical carrier signal with the amplified signal to produce the optical data signal.
